(19) United States
(12) Patent Application Publication
(10) Pub. No.: US 2008/0068761 A1
(43) Pub. Date: Mar. 20, 2008

(54) Magnetoresistive device, read head having the same, and storage having read head

(75) Inventors: Hiroshi Horiguchi, Kawasaki (JP); Koujiro Komagaki, Kawasaki (JP); Koji Hirano, Odawara (JP)

Correspondence Address: GREER, BURNS & CRAIN, 300 S WACKER DR, 25TH FLOOR, CHICAGO, IL, 60606, US

(73) Assignee: Fujitsu Limited, Kawasaki-shi (JP)

(21) Appl. No.: 11/789,855

(22) Filed: Apr. 26, 2007

(30) Foreign Application Priority Data
Sep. 20, 2006 (JP) 2006-254419

(51) Int. Cl. G11B 5/127

(52) U.S. Cl. 360/313; 29/603.03; 977/700

(57) ABSTRACT

A method for manufacturing a magnetic head device that includes a soft magnetic layer includes the steps of forming a plating base layer in the soft magnetic layer through sputtering, and applying, during the forming step, a magnetic field in a direction parallel to an orientation fringe of a wafer in which the magnetic head device is formed.

This application claims the right of foreign priority under 35 U.S.C. §119 based on Japanese Patent Application No. 2006-254419, filed on Sep. 20, 2006, which is hereby incorporated by reference herein in its entirety as if fully set forth herein.

### BACKGROUND OF THE INVENTION

The present invention relates generally to a magnetoresistive (“MR”) device, and more particularly to a structure of the MR device that has a hard bias film that applies a bias magnetic field, and applies the sense current perpendicular to a lamination surface of an MR film that serves as a read sensor film. The present invention is suitable, for example, for a read head for a hard disc drive (“HDD”).

Along with the recent widespread Internet, a magnetic disc drive that stably records and reproduces a large amount of information including still and motion pictures has been increasingly demanded. When the surface recording density is increased so as to meet the large-capacity demand, the 1-bit area as the magnetically recorded information on the recording medium reduces, and the signal magnetic field from the recording medium becomes weaker. In order to read this weak signal magnetic field, a small and sensitive read head is needed.

A current in plane (“CIP”)—giant magnetoresistive (“GMR”) head and a tunneling magnetoresistive (“TMR”) are known as this head. They use the MR device, applies the sense current perpendicular to the lamination surface of the MR device, and arrange a pair of permanent magnet films or hard bias films at both sides of the MR film so as to restrain noises.

This type of MR device makes the hard bias film of such a magnetic material as CoPt alloy and CoCrPt alloy, and provides a pair of shield layers made, for example, of NiFe above and under the MR film to shield the external magnetic field. A nonmagnetic gap layer electrically insulates the hard bias films from the shield layers. The hard bias films, the shield layers, and the gap layer expose on the head's floatation surface of the MR device in addition to the MR film.

Prior art include, for example, Japanese Patent Applications, Publication Nos. (“JP”) 5-62130 and 8-147633.

In order to read the weak signal magnetic field, the head floating above the disc needs to be made closer to the disc, and the floatation surface of the MR device is more likely to collide with the disc due to the reduced head floatation amount. Then, due to the smear of the hard bias film, the bias magnetic field does not work parallel to the lamination surface of the sensor film, and the read sensitivity deteriorates. In addition, when the smear extends to the shield layer beyond the gap layer and the hard bias film and the shield layer are electrically connected to each other (short-circuited), the MR device that flows the sense current perpendicular to the lamination surface becomes defective. It is therefore necessary to protect the hard bias film for the stable recording and reproduction.

### BRIEF SUMMARY OF THE INVENTION

The present invention provides a MR device that can properly protect the hard bias film, a read head having the same, and a storage having the read head.

A magnetoresistive device according to one aspect of the present invention includes a magnetoresistive film, and a pair of hard bias films that apply a bias magnetic field to the magnetoresistive film, sense current being flowing perpendicular to a lamination surface of the magnetoresistive film, and each hard bias film on a section parallel to the lamination surface being at least partially retreating from an exposure surface on which the magnetoresistive film exposes. According to the magnetoresistive device, the hard bias films retreat from the exposure surface, and are less likely to contact the external member and protected from the external impact. The exposure surface corresponds to the floatation surface when the magnetoresistive device is mounted on the head.

For example, the pair of hard bias films on the section form an approximately convex shape that projects toward the exposure surface and is adjacent to the magnetoresistive film. This configuration can protect the hard bias films apart from the magnetoresistive film. Each hard bias film may at least partially retreat from the exposure surface by 10 nm. The hard bias film has an inclined surface on the section, the inclined surface inclining so as to separate from the exposure surface as a distance from the magnetoresistive film increases. The inclined surface is preferable because it can more easily maintain the bias magnetic field than the perpendicular surface that extends perpendicularly to the floatation surface.

Preferably, the inclined surface is symmetrical with respect to a surface that halves the magnetoresistive film and is perpendicular to the exposure surface on the section. Thereby, the bias magnetic field can be easily maintained. An inclination angle of the inclined surface to the exposure surface is, for example, between 30° and 60°. The pair of hard bias films on the section may have a pair of horizontal surfaces parallel to and apart from the exposure surface, a pair of horizontal surfaces forming the same plane. Thereby, the bias magnetic field can be easily maintained.

The magnetoresistive device may further include an insulating layer formed on a surface of each hard bias film at the side of the exposure surface, protecting the hard bias film from exposing from the exposure surface. The insulating layer is made, for example, of Al₂O₃ or SiO₂.

A method according to another aspect of the present invention for manufacturing a magnetoresistive device that has a pair of hard bias films that apply a bias magnetic field to a magnetoresistive film, and flows sense current perpendicular to a lamination surface of the magnetoresistive film includes the steps of forming the hard bias films through sputtering, and forming an insulating layer on a side surface of the hard bias film at a side of an exposure surface on which the magnetoresistive film exposes. This manufacturing method can manufacture the magnetoresistive device that can exhibit the above operations.

The magnetoresistive device manufactured by the above manufacturing method and a read head that includes the above magnetoresistive device, a current supplier that supplies the sense current, and a read part that reads a signal from a change of electric resistance of the magnetoresistive device in accordance with a signal magnetic field constitute one aspect of the present invention. A storage that includes a magnetic head part that includes the above read head and a write head, a driver that drives a magnetic recording medium to be recorded and reproduced by said magnetic head part also constitutes another aspect of the present invention.

Other objects and further features of the present invention will become readily apparent from the following description of preferred embodiments with reference to the accompanying drawings.

### BRIEF DESCRIPTION OF THE DRAWINGS

FIG. 1 is a plane view showing an internal structure of a HDD according to one embodiment of the present invention.

FIG. 2 is an enlarged perspective view of a magnetic head part in the HDD shown in FIG. 1.

FIG. 3A is an enlarged plane view of a conventional layered structure of a head shown in FIG. 2 when the head is viewed from its floatation surface.

FIG. 3B is a sectional view taken along a line A-A shown in FIG. 3A.

FIG. 4A is an enlarged plane view of a layered structure of the head shown in FIG. 2 according to a first embodiment of the present invention when the head is viewed from the floatation surface.

FIG. 4B is a sectional view taken along a line B-B shown in FIG. 4A.

FIG. 5A is an enlarged plane view of a layered structure of the head shown in FIG. 2 according to a second embodiment of the present invention when the head is viewed from the floatation surface.

FIG. 5B is a sectional view taken along a line C-C shown in FIG. 5A.

FIG. 6A is a flowchart for manufacturing the conventional layered structure shown in FIG. 3A.

FIG. 6B is schematic sectional and plane views of each step in the flowchart shown in FIG. 6A.

FIG. 7A is a flowchart for manufacturing the layered structure of the second embodiment shown in FIG. 5A.

FIG. 7B is schematic sectional and plane views of each step in the flowchart shown in FIG. 7A.

FIG. 8A is a flowchart of a variation of the method shown in FIG. 7A.

FIG. 8B is schematic sectional and plane views of each step in the flowchart shown in FIG. 8A.

FIG. 9A is a flowchart of another variation of the method shown in FIG. 7A.

FIG. 9B is schematic sectional and plane views of each step in the flowchart shown in FIG. 9A.

### DETAILED DESCRIPTION OF THE PREFERRED EMBODIMENTS

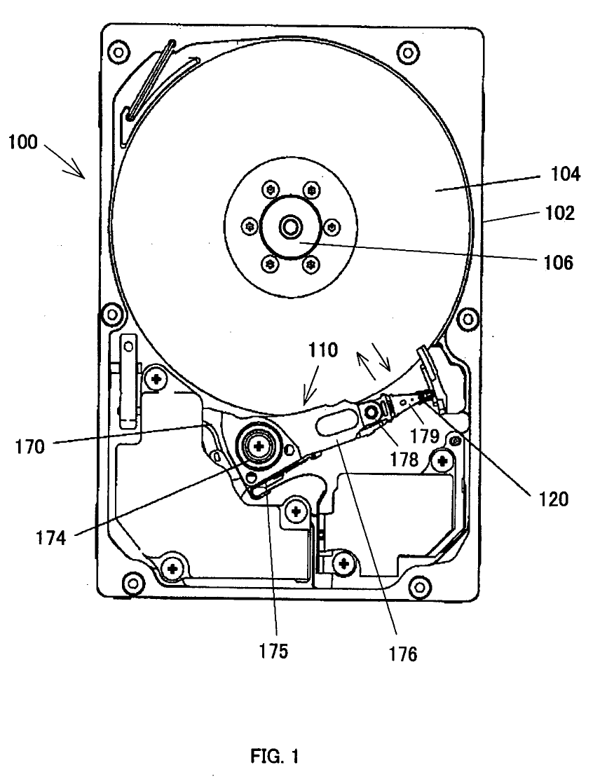

Referring now to the accompanying drawings, a description will be given of a HDD 100 according to one embodiment of the present invention. The HDD 100 includes, as shown in FIG. 1, one or more magnetic discs 104 each serving as a recording medium, a spindle motor 106, and a head stack assembly (“HSA”) 110 in a housing 102. Here, FIG. 1 is a schematic perspective view showing the internal structure of the HDD 100.

The housing 102 is made, for example, of aluminum die cast base and stainless steel, and has a rectangular parallelepiped shape, to which a cover (not shown) that seals the internal space is joined. The magnetic disc 104 has a high surface recording density, such as 100 Gb/in² or greater. The magnetic disc 104 is mounted on a spindle hub of the spindle motor 106 through its center hole.

The spindle motor 106 has, for example, a brushless DC motor (not shown) and a spindle as its rotor part. For instance, two magnetic discs 104 are used in order of the disc, a spacer, the disc and a clamp stacked on the spindle, and fixed by bolts coupled with the spindle.

The HSA 110 includes a magnetic head part 120, a carriage 170, a base plate 178, and a suspension 179.

The magnetic head part 120 includes a slider 121, and a head device built-in film 123 that is joined with an air outflow end of the slider 121 and has a read/write head 122.

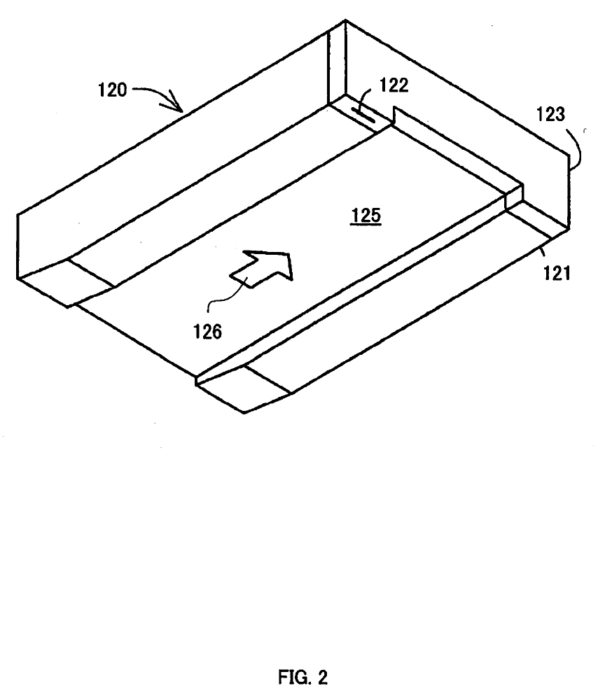

The slider 121 has an approximately rectangular parallelepiped shape, and is made of Al₂O₃—TiC (Altic). The slider 121 supports the head 122 and floats from the surface of the disc 104. The head 122 records information in and reproduces information from the disc 104. The surface of the slider 121 opposing to the magnetic disc 104 serves as a floatation surface 125, which receives an airflow 126 that occurs with rotations of the magnetic disc 104. Here, FIG. 2 is a schematic perspective view of the magnetic head part 120.

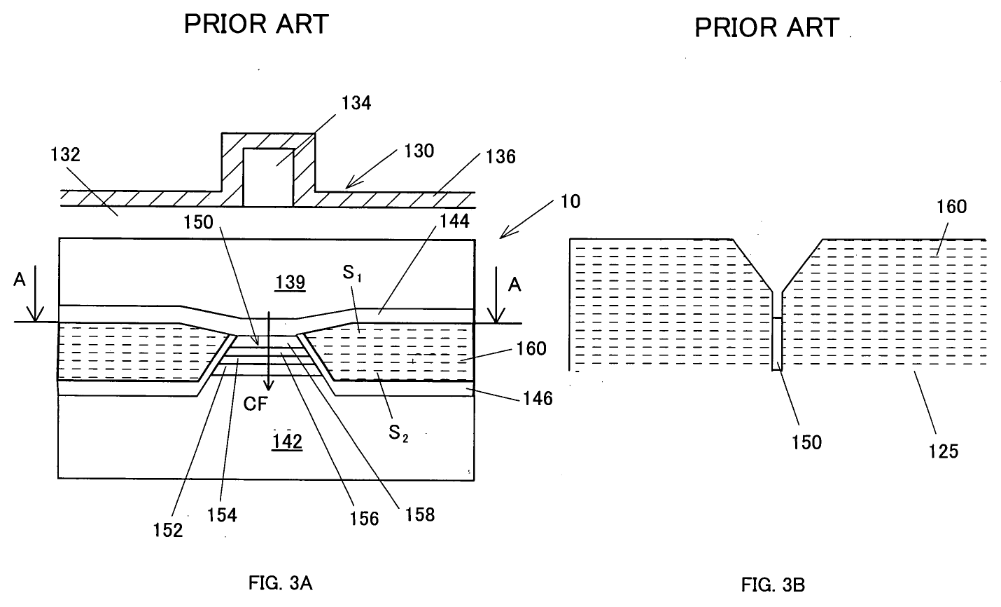

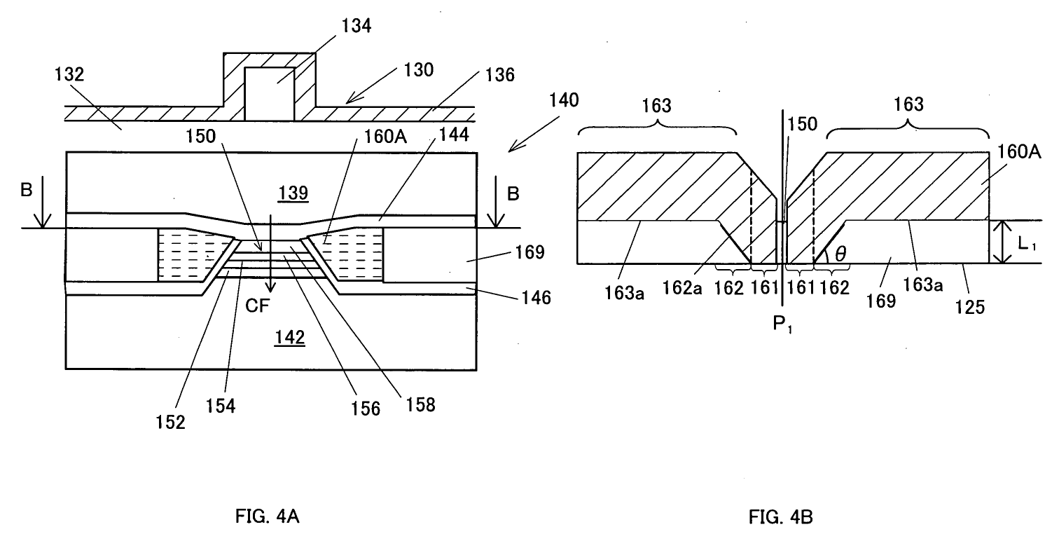

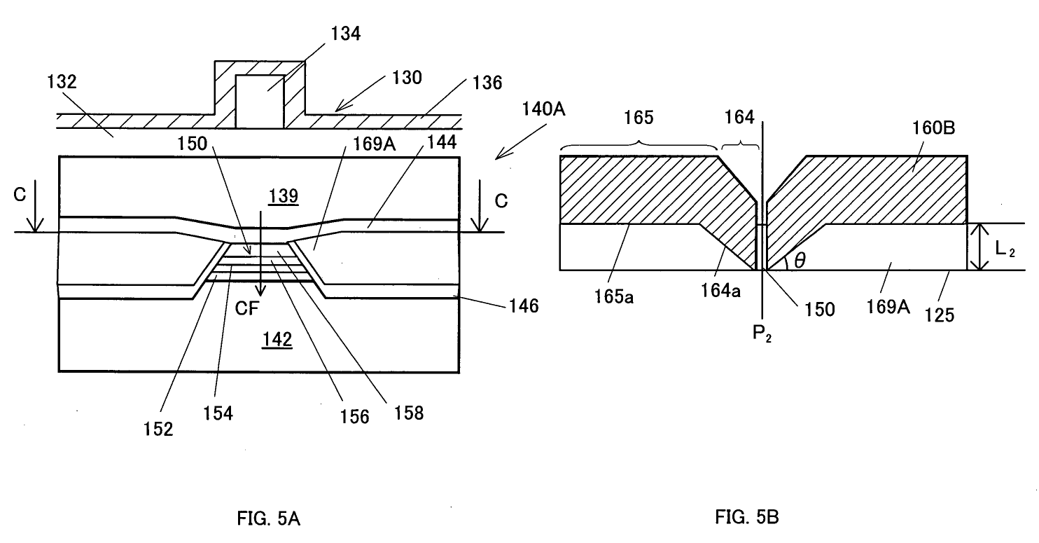

FIG. 3A is an enlarged plane view of the conventional head. FIG. 4A is an enlarged plane view of the head 122 according to a first embodiment of the present invention. FIG. 5A is an enlarged plane view of the head 122 according to a second embodiment of the present invention.

The head 122 is, for example, a MR/inductive composite head that includes an inductive head device 130 that writes binary information in the magnetic disc 104 utilizing the magnetic field generated by a conductive coil pattern (not shown), and an MR head 140 that reads the binary information based on the resistance that varies in accordance with the magnetic field applied by the magnetic disc 104.

The conventional head shown in FIG. 3A has the inductive head device 130 and an MR head device 10. The head shown in FIG. 4A has the inductive head device 130 and the MR head device 140. The head shown in FIG. 5A has the inductive head device 130 and the MR head device 140A. FIGS. 3A, 4A, and 5B are schematic plane views of the MR head devices 10, 140 and 140A viewed from the floatation surface 125.

The inductive head device 130 includes a nonmagnetic gap layer 132, an upper magnetic pole layer 134, an insulating film 136 made of an Al₂O₃ film, and an upper shield-upper electrode layer 139. As discussed later, the upper shield-upper electrode layer 139 also constitutes part of the MR head device 10, 140, or 140A.

The nonmagnetic gap layer 132 spreads over a surface of the upper shield-upper electrode layer 139, and is made, for example, of Al₂O₃. The upper magnetic pole layer 134 opposes to the upper shield-upper electrode layer 139 with respect to the nonmagnetic gap layer 132, and is made, for example, of NiFe. The insulating film 136 extends over a surface of the nonmagnetic gap layer 132, covers the upper magnetic pole layer 134, and forms the head-device built-in film 123. The upper magnetic pole layer 134 and upper shield-upper electrode layer 139 cooperatively form a magnetic core in the inductive write head device 130. The lower magnetic pole layer in the inductive write head device 130 serves as the upper shield-upper electrode layer 139 in the MR head device 140. As the conductive coil pattern induces a magnetic field, a magnetic-flux flow between the upper magnetic pole layer 134 and upper shield-upper electrode layer 139 leaks from the floatation surface 125 due to acts of the non-magnetic gap layer 132. The leaking magnetic-flux flow forms a signal magnetic field or gap magnetic field.

The conventional MR head device 10 includes, as shown in FIG. 3A, the upper shield layer 139, a lower shield layer 142, an upper gap layer 144, a lower gap layer 146, an MR film 150, and a pair of hard bias films 160 that are provided at both sides of the MR film 150.

The MR head device 140 includes, as shown in FIG. 4A, the upper shield layer 139, the lower shield layer 142, the upper gap layer 144, the lower gap layer 146, the MR film 150, the pair of hard bias films 160A that are provided at both sides of the MR film 150, and an insulating layer 169. The MR head devices 140 and 10 are different from each other in that the MR head device 140 has the hard bias films 160A whereas the MR head device 10 has the hard bias film 160, and the MR head device 140 has the insulating layer 169 whereas the MR head device 10 has no insulating layer.

The MR head device 140A includes, as shown in FIG. 5A, the upper shield layer 139, the lower shield layer 142, the upper gap layer 144, the lower gap layer 146, the MR film 150, a pair of hard bias films 160B that are provided at both sides of the MR film 150, and an insulating layer 169A. The MR head devices 140A and 10 are different from each other in that the MR head device 140A has the hard bias films 160B whereas the MR head device 10 has the hard bias film 160, and the MR head device 140A has the insulating layer 169A whereas the MR head device 10 has no insulating layer.

The shield layers 139 and 142 are made, for example, of NiFe. The gap layers 144 and 146 are made of an insulating material, such as Ta and Al₂O₃.

The MR film 150 is made, for example, of a TMR film, which includes, in order from the bottom in FIGS. 3A, 4A and 5A, a free ferromagnetic layer 152, a nonmagnetic insulating layer 154, a pinned magnetic layer 156, and an antiferromagnetic layer 158. The TMR film has a ferromagnetic tunneling junction configured to hold the insulating layer 154 between the two ferromagnetic layers, and uses a tunneling phenomenon in which the electrons in the minus side ferromagnetic layer pass through the insulating layer to the plus side ferromagnetic layer, when the voltage is applied between the two ferromagnetic layers. The insulating layer 154 uses, for example, an Al₂O₃ film.

The MR film 150 may be a spin-valve film. In that case, the MR device becomes a CPP-GMR device, and includes, in order from the bottom shown in FIGS. 3A, 4A, and 5A, a free layer 152, a nonmagnetic intermediate layer 154, a pinned magnetic layer 156, and an exchange-coupling (antiferromagnetic) layer 158. Usually, a protective layer and a nonmagnetic primary coat, such as Ta, are added above the exchange-coupling layer and under the free layer. In addition, the spin-valve film 150 may have any types including a top-type spin-valve structure, a bottom-type spin-valve structure, and a dual spin valve structure.

Thus, the MR head device 10, 140, or 140A has a CPP structure that applies the sense current perpendicular to the lamination surface of the MR film 150 or parallel to the lamination direction, as shown by an arrow CF.

The hard bias film 160 generates a bias magnetic field that restrains noises. The hard bias film 160 is made, for example, of such a magnetic material as CoPt alloy and CoCrPt alloy. This embodiment makes the hard bias film 160 of CoCrPt alloy. Usually, a primary coat, such as Cr, CrTi alloy and TiW alloy, is added to the hard bias film 160. For the CPP-GMR device, the insulating film is layered on the hard bias film 160.

FIG. 3B is a sectional view taken along a line A-A in FIG. 3A or a schematic plane view of the hard bias film 160 and the MR film 150 before the upper gap layer 144 and the upper shield layer 139 shown in FIG. 3A are layered. Similarly, FIG. 4B is a sectional view taken along a line B-B in FIG. 4A or a schematic plane view of the hard bias film 160A, the insulating layer 169, and the MR film 150 before the upper gap layer 144 and the upper shield layer 139 shown in FIG. 4A are layered. FIG. 5B is a sectional view taken along a line C-C in FIG. 5A or a schematic plane view of the hard bias film 160B, the insulating layer 169A, and the MR film 150 before the upper gap layer 144 and the upper shield layer 139 shown in FIG. 5A are layered. In FIGS. 3B, 4B and SB, the bottom surface is the floatation surface 125 and serves as the exposure surface, on which the MR film 150 exposes.

The hard bias films 160 of the conventional MR device 10 expose on the floatation surface 125. Therefore, as shown in FIG. 3A, the hard bias films 160 collide with the disc 104 on the floatation surface 125, and smears S₁ and S₂ are likely to occur. The smear S₁ short-circuits the hard bias film 160 to the upper shield layer 139, and the smear S₂ short-circuits the hard bias film 160 to the lower shield layer 142. As a result, the sense current does not properly flow through the MR film 150, and the MR head device 10 is likely to be defective. In particular, the head's floatation amount would reduce for the future high recording-density disc, and the hard bias films 160 are highly likely to collide with the disc 104.

On the other hand, the hard bias films 160A and 160B at least partially retreat from the floatation surface or exposure surface 125. The hard bias films 160A expose on the floatation surface 125 in the area 161, and retreat or space from the floatation surface 125 in the areas 162 and 163. In other words, the hard bias films 160A do not expose from the floatation surface 125 in the areas 162 and 163. The hard bias films 160B have substantially no exposing part from the floatation surface 125, and retreat or space from the floatation surface 125 in the areas 164 and 165. In the MR head devices 140 and 140A, the hard bias films 160A and 160B retreat from the floatation surface 125, are less likely to contact the disc 104, and are protected from the external impacts.

A smaller horizontal length is preferable for the area 161 shown in FIG. 4B. FIG. 5B shows that the area 161 has no horizontal length. However, it is difficult in view of the cost and manufacturing technology to eliminate the horizontal length of the area 161. Accordingly, the present invention allows a slight horizontal length of the area 161.

A pair of hard bias films 160A have, as shown in FIG. 4B, an approximately convex shape that projects to the floatation surface 125 side in the areas 161 and 162 as adjacent parts to the MR film 150. A pair of hard bias films 160B have, as shown in FIG. 5B, an approximately convex shape that projects to the floatation surface 125 side in the area 164 as adjacent part to the MR film 150. Thereby, the hard bias films 160A and 160B are protected in the areas 163 and 165 apart from the MR film 150.

10 nm is enough for retreat amounts L₁ and L₂ of the hard bias amounts 160A and 160B in the areas 163 and 165.

The hard bias film 160A has an area 162 with an inclined surface 162a on the floatation surface 125 side, and the inclined surface 162a inclines so as to separate from the floatation surface 125 as a horizontal distance from the MR film 150 increases. The hard bias film 160B has an area 164 with an inclined surface 164a on the floatation surface 125 side, and the inclined surface 164a inclines so as to separate from the floatation surface 125 as a horizontal distance from the MR film 150 increases. The inclined surfaces 162a and 164a are preferable because they can more easily maintain the bias magnetic field than the perpendicular surfaces (or the inclined surfaces with an angle θ of 90° in FIGS. 4B and 5B), which extend perpendicularly to the floatation surface 125. The inclination angle θ of the inclined surfaces 162a and 164a are preferably maintained between 30° and 60°. The angle greater than 60° has a difficulty in maintaining the bias magnetic field, and the angle smaller than 30° cannot maintain a sufficient retreat amount of the hard bias film from the floatation surface 125.

The hard bias film 160A has an area 163 having a horizontal surface 163a on the side of the floatation side 125, and the horizontal surface 163a is parallel to and retreats from the floatation surface 125. In addition, the hard bias film 160B has an area 165 having a horizontal surface 165a on the side of the floatation side 125, and the horizontal surface 165a is parallel to and retreats from the floatation surface 125.

The inclined surface 162a and the horizontal surface 163a are symmetrical with respect to a surface P₁ that is perpendicular to the floatation surface 125, and halves the MR film 150 on the section shown in FIG. 4B. The inclined surface 164a and the horizontal surface 165a are symmetrical with respect to a surface P₂ that is perpendicular to the floatation surface 125, and halves the MR film 150 on the section shown in FIG. 5B.

The horizontal lengths of the areas 162 and 164 suffer no restriction. The hard bias films 160 and 160A do not have to have the horizontal surfaces 163a and 165a.

The MR device 140 has the insulating layer 169 that is formed on the side surface of the hard bias films 160A on the floatation surface 125 side (i.e., on the inclined surface 162a and the horizontal surface 163a). The MR device 140A has the insulating layer 169A that is formed on the side surface of the hard bias film 160A on the floatation surface 125 side (i.e., on the inclined surface 164a and the horizontal surface 165a). Thereby, the insulating layer 169 prevents the hard bias films 160A from exposing on the floatation surface 125, and the insulating layer 169A prevents the hard bias films 160B from exposing on the floatation surface 125. The insulating layers 169 and 169A are made, for example, of Al₂O₃ or SiO₂. When the lower gap layer 146, and the insulating layers 169 and 169A are made of Al₂O₃, boundaries are invisible between the lower gap layer 146 and the insulating layer 169 in FIG. 4A and between the lower gap layer 146 and the insulating layer 169A in FIG. 5A.

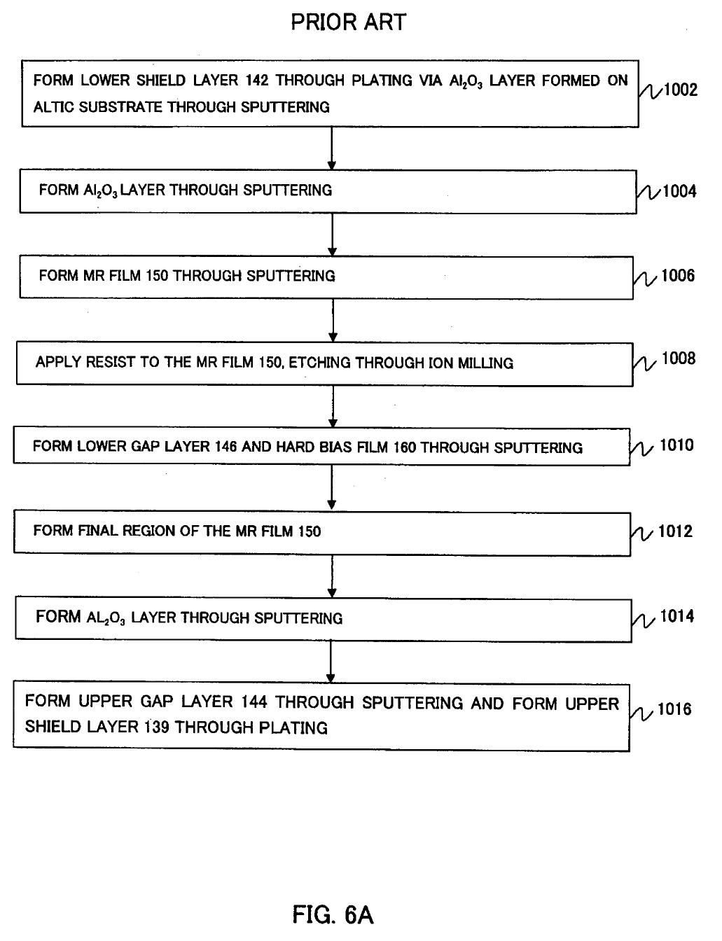

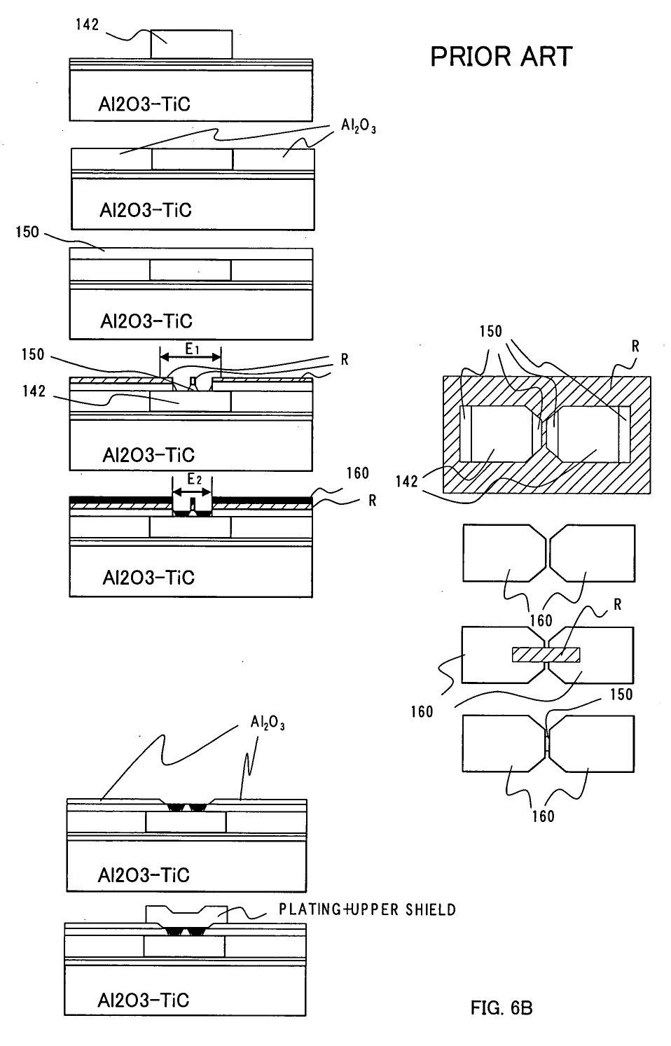

Referring now to FIGS. 6A and 6B, a description will be given of a method for manufacturing the conventional MR head device 10. Here, FIG. 6A us a flowchart for manufacturing the MR head device 10 shown in FIG. 3A. FIG. 6B is a schematic plane view of each step in the flowchart shown in FIG. 6A.

Referring to FIG. 6A, the lower shield layer 142 is formed through plating via the Al₂O₃ layer that is formed on the Altic substrate through sputtering (step 1002, left top sectional view in FIG. 6B). Next, an alumina (Al₂O₃) layer is formed through sputtering (step 1004, left second sectional view from the top in FIG. 6B). Next, the MR film 150 is formed through sputtering (step 1006, left third sectional view from the top in FIG. 6B).

Next, the MR film 150 is etched through ion milling via the application of the resist R (step 1008, left fourth sectional view from the top in FIG. 6B). A right top enlarged plane view in FIG. 6B shows an E₁ part near the MR film 150 of that state.

Next, the lower gap film 146 and the hard bias film 160 are formed through sputtering (step 1010, left third sectional view from the bottom in FIG. 6B). A right second enlarged plane view from the top in FIG. 6B shows an E₂ part near the MR film 150 of that state. The MR film 150 is provided between and around the hard bias films 160. The hard bias films 160 at both sides of the MR film 150 each have a rectangular shape with two adjacent chambered corners. A pair of hard bias films 160 are arranged so that two sides each having the chamfered corners at both ends oppose to each other.

Next, the rectangular resist R is applied to the hard bias films 160 and unnecessary part is removed from the MR film 150 so as to form the final region (step 1012). A right second plane view from the bottom in FIG. 6B shows the resist R applied to the hard bias film 160. The resist R covers the center between a pair of hard bias films 160 so as to remove the MR film 150 outside this area. A width of the rectangular resist R determines a width of the MR film 150, and a shape of the other part is not limited to the rectangle. In addition, a right bottom enlarged plane view in FIG. 6B shows the MR film 150 and the hard bias film 160 from which the resist R is removed. It is understood that an area of the MR film 150 is limited to the center between a pair of hard bias films 160. The shape is finally cut in a lateral direction, and becomes as shown in FIG. 3B.

Next, the Al₂O₃ layer is formed through sputtering (step 1014, left second sectional view from the bottom in FIG. 6B). Next, the upper gap layer 144 is formed through sputtering, and the upper shield layer 139 is formed through plating (step 1016, left bottom sectional view in FIG. 6B).

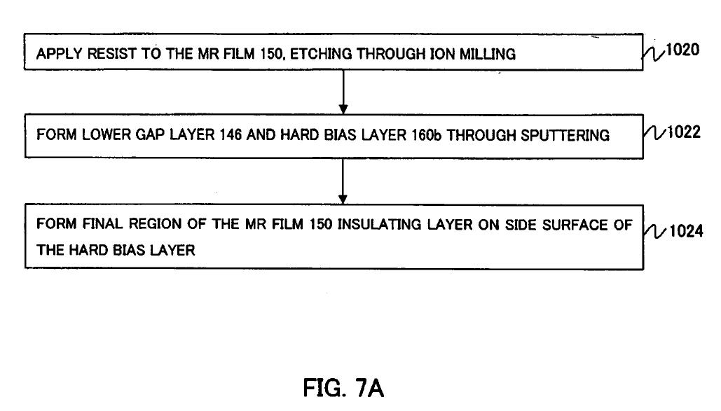

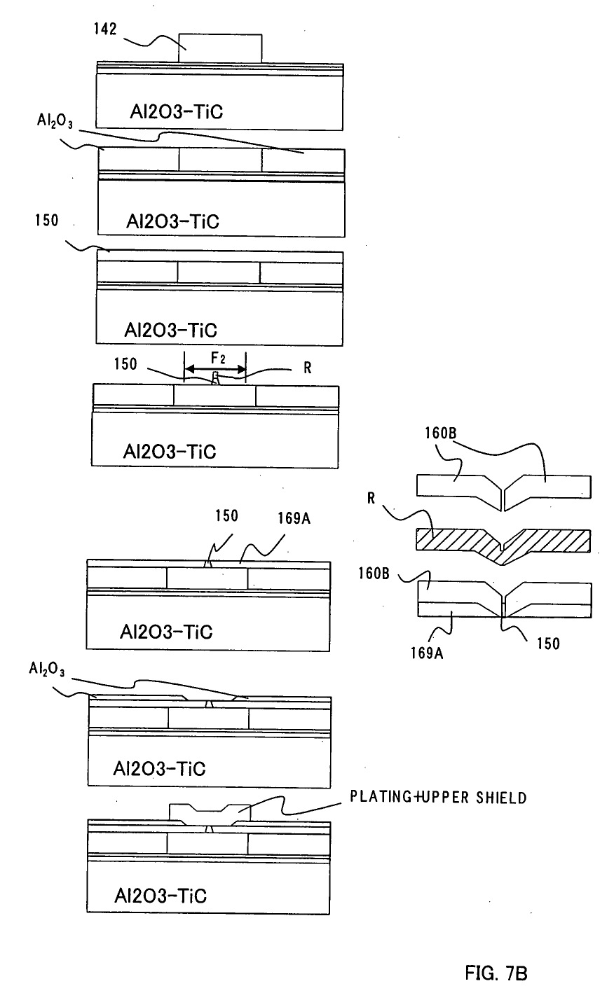

Referring now to FIGS. 7A and 7B, a description will be given of a method for manufacturing the MR head device 140A shown in FIG. 5A. Unless the area 161 is eliminated, this manufacturing method is applicable to the MR head device 140 shown in FIG. 5A. Here, FIG. 7A is a flowchart for manufacturing the MR head device 140A. FIG. 7B is a schematic plane view of each step in the flowchart shown in FIG. 7A. Those steps in FIG. 7A, which are the same as the corresponding steps in FIG. 6A, are designated by the same reference numerals, and a duplicate description will be omitted. The flowchart shown in FIG. 7A is different from that shown in FIG. 6A in that the flowchart shown in FIG. 7A has the steps 1020 to 1024 instead of the steps 1008 to 1012.

The step 1020 etches the MR film 150 through ion milling via the resist application.

Next, the lower gap layer 146 and the hard bias film 160B are formed through sputtering (step 1022). A left fourth sectional view from the bottom in FIG. 7B shows the state before the hard bias film 160B is formed. A right top enlarged plane view in FIG. 7B shows an F₂ part near the MR device 150 after the hard bias film 160B is formed. It is understood that the right top plane view in FIG. 7B is different in shape from the right second plane view from the top in FIG. 6B. The MR film 150 is formed between and around the hard bias films 160B. In FIGS. 7A and 7B, the hard bias films 160B formed at both sides of the MR film 150 have a shape that combines a rectangle with a parallelogram. A pair of hard bias films 160B are arranged so that the bent parts oppose to each other.

Next, the resist R is applied to the hard bias films 160B to remove unnecessary part from the MR film 150 through ion milling, and to create the final region. The insulating film 169A is formed on the side surface (i.e., on the inclined surface 164a and the horizontal surface 165a) of the hard bias film 160B through sputtering (step 1024, left third sectional view from the bottom in FIG. 7B). In that case, the right second plane view from the bottom in FIG. 7B shows the resist R applied to the hard bias films 160B. The resist R covers the lower side between a pair of hard bias films 160B, and the part other than this region is removed from the MR film 150. It is understood that the right second plane view from the bottom in FIG. 7B is different from the right plane view from the bottom in FIG. 6B in a shape of the resist R. The resist R has a similar shape to the hard bias film 160B, but is connected at the center bottom so as to cover the center bottom of the hard bias film 160B.

The left third sectional view from the bottom in FIG. 7B shows the MR film 150 and the hard bias film 160B after the resist R is removed, and the right bottom view in FIG. 7B is its plane view. It is understood that the region of the MR film 150 is limited to the lower side between a pair of hard bias film 160B, and that the insulating layer 169A is as level as the hard bias films 160B. The step 1024 protects the inclined surface 164a and the horizontal surface 165a of the hard bias film 160B.

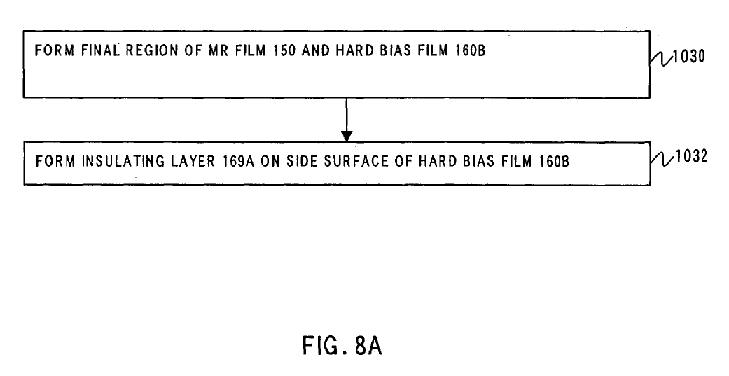

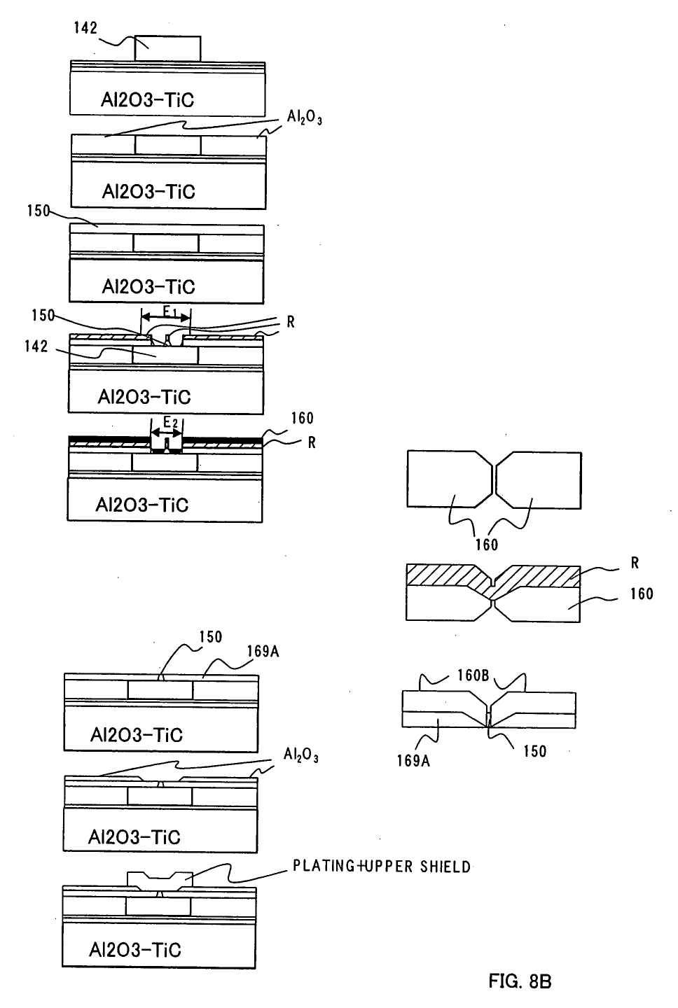

While FIGS. 7A and 7B limit the region of the MR film 150 after the hard bias films 160B are formed, the final regions of the MR film 150 and the hard bias film 160B may be formed simultaneously. Referring now to FIGS. 8A and 8B, a manufacturing method of that embodiment will be described. Here, FIG. 8A is a flowchart for manufacturing the MR head device 140A. FIG. 8B is a schematic plane view of each step in FIG. 8A. Those steps in FIG. 8A, which are the same as corresponding steps in FIG. 6A, are designated by the same reference numerals, and a duplicate description will be omitted. The flowchart shown in FIG. 8A is different from that shown in FIG. 6A in that the flowchart shown in FIG. 8A has the steps 1030 and 1032 instead of the step 1012.

The step 1030 forms the final regions of the hard bias film 160B and the MR film 150. In other words, this step forms the hard bias film 160B shown in the right top view in FIG. 8B similar to the right second view from the top in FIG. 6B. Next, this step forms, on the hard bias film 160B, the resist R that has the same shape as the resist R in the right second view in FIG. 7B so that the upper end of the resist R accords with the upper end of the hard bias film 160B. Parts of the MR film 150 and the hard bias film 160B are simultaneously removed through ion milling. The right second plane view from the bottom in FIG. 8B shows the resist R applied onto the hard bias film 160B.

Next, the insulating layer 169A is formed through sputtering on the side surface of the hard bias film 160B (i.e., the inclined surface 164a and the horizontal surface 165a shown in FIG. 5B) (step 1032, left third sectional view from the bottom shown in FIG. 8B). The left third sectional view from the bottom in FIG. 8B shows the hard bias film 160B and the MR film 150 after the resist R is removed, and the right bottom plane view in FIG. 8B is its plane view. It is understood that the region of the MR film 150 is limited to the lower end between a pair of hard bias films 160B. The insulating layer 169A is formed as level as the hard bias films 160B. The step 1032 protects the inclined surface 164a and the horizontal surface 165a of the hard bias film 160B.

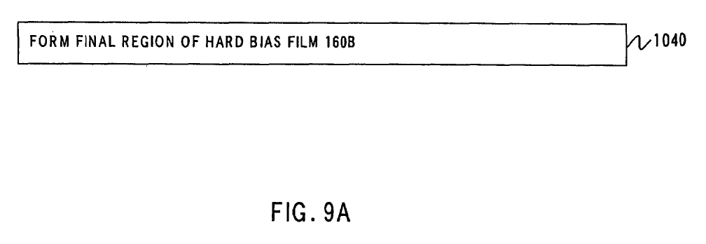

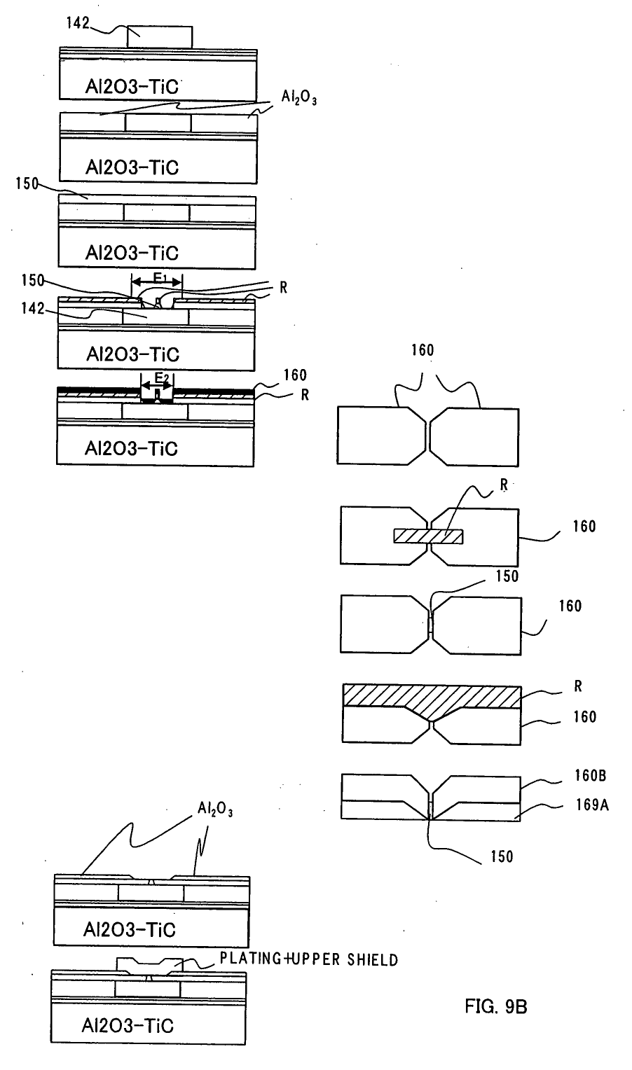

Alternatively, as another variation of the manufacturing method shown in FIGS. 6A and 6B, the final region of the hard bias film 160B can be made after the final region of the MR film 150 may be formed. Referring now to FIGS. 9A and 9B, a description of an illustration of the manufacturing method will be given. Here, FIG. 9A is a flowchart for manufacturing the MR head device 140A. FIG. 9B is a schematic plane view of each step in the flowchart shown in FIG. 9A. Those steps in FIG. 9A, which are the same as corresponding steps in FIGS. 6A and 8A, are designated by the same reference numerals, and a duplicate description will be omitted. The flowchart shown in FIG. 9A is different from that shown in FIG. 6A in that the flowchart shown in FIG. 9A has the steps 1040-1042 after the step 1012.

The step 1012 creates the final region of the MR film 150. Here, the final region of the MR film 150 is created at the center between a pair of hard bias films 160 in a manner similar to the four right plane views in FIG. 6B. Three right top plane views in FIG. 9B are the same as three right bottom plane views in FIG. 6B.

Next, the final region of the hard bias film 160B is created (step 1040). More specifically, the right third resist R from the top in FIG. 9B is formed on the hard bias films 160B so that the upper end of the resist R accords with the upper end of the hard bias film 160B, and part of the hard bias film 160B is removed through ion milling. The right second plane view from the bottom in FIG. 9B shows the resist R applied to the hard bias films 160B in that state. The right second plane view from the bottom in FIG. 9B is different from the right second plane view from the bottom in FIG. 7B in a shape of the applied resist R, but both shapes may be the same. In the right second plane view from the bottom in FIG. 9B, the resist R has a shape that combines an isosceles triangle with the center of the rectangle. In the right second plane view from the bottom in FIG. 7B, the resist R has a Y-shaped concave on the side opposite to the isosceles triangle of the resist R in the right second plane view from the bottom in FIG. 9B.

Next, the step 1032 follows.

It is understood that also in FIGS. 9A and 9B, the region of the MR film 150 is limited to the lower end between a pair of hard bias films 160B, and that the insulating layer 169A is formed as level as the hard bias films 160B. The step 1032 protects the insulated surface 164a and the horizontal surface 165a of the hard bias film 160B.

Turning back to FIG. 1, the carriage 170 serves to rotate or swing the magnetic head part 120 in the arrow directions shown in FIG. 1, and includes a voice coil motor (not shown), a shaft 174, a flexible printed circuit board (“FPC”) 175, and an arm 176.

The voice coil motor has a flat coil between a pair of yokes. The flat coil opposes to a magnetic circuit (not shown) provided to the housing 102, and the carriage 170 swings around the shaft 174 in accordance with values of the current that flows through the flat coil. The magnetic circuit includes, for example, a permanent magnet fixed onto an iron plate fixed in the housing 102, and a movable magnet fixed onto the carriage 170.

The shaft 174 is inserted into a hollow cylinder in the carriage 170, and extends perpendicular to the paper surface of FIG. 1 in the housing 102. The FPC 175 provides the wiring part with a control signal, a signal to be recorded in the disc 104, and the power, and receives a signal reproduced from the disc 104.

The arm 176 is an aluminum rigid body, and has a perforation hole at its top. The suspension 179 is attached to the arm 176 via the perforation hole and the base plate 178.

The base plate 178 serves to attach the suspension 179 to the arm 176, and includes a welded section, and a dent or dowel. The welded portion is laser-welded with the suspension 179. The dent is a part to be swaged with the arm 176.

The suspension 179 serves to support the magnetic head part 120 and to apply an elastic force to the magnetic head part 120 against the magnetic disc 104, and is, for example, a stainless steel suspension. The suspension 179 has a flexure (also referred to as a gimbal spring or another name) which cantilevers the magnetic head part 120, and a load beam (also referred to as a load arm or another name) which is connected to the base plate 178. The load beam has a spring part at its center so as to apply sufficient compression force in the Z direction. The suspension 179 also supports a wiring part that is connected to the magnetic head part 120 via a lead etc.

In operation of the HDD 100, the spindle motor 106 rotates the disc 104. The airflow associated with the rotations of the disc 104 is introduced between the disc 104 and slider 121, forming a fine air film and thus generating the floating force that enables the slider 121 to float over the disc surface. The suspension 179 applies the elastic compression force to the slider 121 against the floating force of the slider 121. As a result, a balance is formed between the floating force and the elastic force.

This balance spaces the magnetic head part 120 from the disc 104 by a constant distance. Next, the carriage 170 rotates around the shaft 174 for head's seek for a target track on the disc 104. In writing, data that is received from a host such as a PC, modulated and amplified is supplied to the inductive head device 130. Thereby, the inductive head device 130 writes down the data onto the target track. In reading, the sense current is supplied to the MR head device 140, and the MR head device 140 reads desired information from the desired track on the disc 104. The MR head device 140 sensitively and stably reads the signal magnetic field because its hard bias films are protected.

Further, the present invention is not limited to these preferred embodiments, and various modifications and variations may be made without departing from the spirit and scope of the present invention. For example, the present invention is applicable, in addition to a magnetic head, to a magnetic sensor, such as a magnetic potentiometer that detects a displacement and an angle, reading of a magnetic card, and recognition of a paper bill printed in magnetic ink.

Thus, the present invention can provide a method of manufacturing a highly sensitive magnetic head device having a good shield characteristic.

What is claimed is:

1. A magnetoresistive device comprising:
a magnetoresistive film; and
a pair of hard bias films that apply a bias magnetic field to said magnetoresistive film, sense current being flowing perpendicular to a lamination surface of said magnetoresistive film, and each hard bias film on a section parallel to the lamination surface being at least partially retreating from an exposure surface on which said magnetoresistive film exposes.

2. A magnetoresistive device according to claim 1, wherein the pair of hard bias films on the section form an approximately convex shape that projects toward the exposure surface and is adjacent to said magnetoresistive film.

3. A magnetoresistive device according to claim 1, wherein each hard bias film at least partially retreats from the exposure surface by 10 nm.

4. A magnetoresistive device according to claim 1, wherein each hard bias film has an inclined surface on the section, the inclined surface inclining so as to separate from the exposure surface as a distance parallel to the exposure surface increases from said magnetoresistive film.

5. A magnetoresistive device according to claim 4, wherein the inclined surface is symmetrical with respect to a surface that halves the magnetoresistive film and is perpendicular to the exposure surface on the section.

6. A magnetoresistive device according to claim 4, wherein an inclination angle of the inclined surface to the exposure surface is between 30° and 60°.

7. A magnetoresistive device according to claim 1, wherein the pair of hard bias films have a pair of horizontal surfaces parallel to and apart from the exposure surface, a pair of horizontal surfaces forming the same plane.

8. A magnetoresistive device according to claim 1, further comprising an insulating layer formed on a side surface of each hard bias film at a side of the exposure surface.

9. A magnetoresistive device according to claim 8, wherein the insulating layer is made of Al₂O₃ or SiO₂.

10. A read head that reads a signal magnetic field, said read head comprising a magnetoresistive device that includes a magnetoresistive film, and a pair of hard bias films that apply a bias magnetic field to the magnetoresistive film, sense current being flowing perpendicular to a lamination surface of the magnetoresistive film, and each hard bias film on a section parallel to the lamination surface being at least partially retreating from an exposure surface on which the magnetoresistive film exposes.

11. A storage comprising:
a magnetic head part that includes a read head and a write head;
a driver that drives a magnetic recording medium to be recorded and reproduced by said magnetic head part,
wherein the read head includes a magnetoresistive device that includes a magnetoresistive film, and a pair of hard bias films that apply a bias magnetic field to the magnetoresistive film, sense current being flowing perpendicular to a lamination surface of the magnetoresistive film, and each hard bias film on a section parallel to the lamination surface being at least partially retreating from an exposure surface on which the magnetoresistive film exposes.

12. A method for manufacturing a magnetoresistive device that has a pair of hard bias films that apply a bias magnetic field to a magnetoresistive film, and flows sense current perpendicular to a lamination surface of the magnetoresistive film, said method comprising the steps of:
forming the hard bias films through sputtering; and
forming an insulating layer on a side surface of each hard bias film at a side of an exposure surface on which the magnetoresistive film exposes.
